(19) United States
(12) Patent Application Publication
(10) Pub. No.: US 2026/0052437 A1
(43) Pub. Date: Feb. 19, 2026

(54) METHOD AND SYSTEM FOR DYNAMIC HANDOVER TRIGGER SERVICE

(71) Applicant: Verizon Patent and Licensing Inc., Basking Ridge, NJ (US)

(72) Inventors: Susan Wu Sanders, Bridgewater, NJ (US); Anil Babu Vontikommu, Morris Plains, NJ (US); Shuang Echo Yang, Naperville, IL (US); Cindy Yuexin Dong, Bridgewater, NJ (US)

(21) Appl. No.: 18/802,181

(22) Filed: Aug. 13, 2024

(51) Int. Cl. H04W 36/00; H04B 17/309; H04W 36/32

(52) U.S. Cl. CPC H04W 36/00837; H04B 17/346; H04W 36/0058; H04W 36/008355; H04W 36/324

(57) ABSTRACT

A method, a device, and a non-transitory computer-readable storage medium are described in relation to a dynamic handover trigger service. The dynamic handover trigger service may store optimized and adjustable levels of handover threshold information for use in triggering a handover for end devices. The dynamic handover trigger service may include measurement and calculation of uplink radio condition values, end device capabilities and mobility, and application service information for comparison to the handover threshold information and enable handover decisions.

### BACKGROUND

Typically, a wireless network and an end device may perform a handover procedure to manage mobility based on various criteria.

### BRIEF DESCRIPTION OF THE DRAWINGS

FIG. 1 is a diagram illustrating an exemplary environment in which an exemplary embodiment of a dynamic handover trigger service may be implemented;

FIGS. 2A-2E are diagrams illustrating an exemplary process of an exemplary embodiment of the dynamic handover trigger service according to exemplary scenario;

FIG. 3A is a diagram illustrating exemplary dynamic handover threshold information of an exemplary embodiment of the dynamic handover trigger service;

FIG. 3B is a diagram illustrating an exemplary process of the dynamic handover trigger service;

FIG. 4 is a diagram illustrating exemplary components of a device that may correspond to one or more of the devices illustrated and described herein; and

FIG. 5 is a flow diagram illustrating an exemplary process of an exemplary embodiment of the dynamic handover trigger service.

### DETAILED DESCRIPTION

The following detailed description refers to the accompanying drawings. The same reference numbers in different drawings may identify the same or similar elements. Also, the following detailed description does not limit the invention.

In a Fifth Generation (5G) network, handover triggers and handover decisions may be based on downlink (DL) metrics. For example, a handover trigger may be based on downlink radio frequency (RF) conditions, such as Reference Signal Received Power (RSRP), Reference Signal Received Quality (RSRQ), and/or Signal-to-Interference-plus-Noise Ratio (SINR). The handover trigger may enable determination of downlink radio frequency coverage or quality associated with an end device, for example.

A radio access network (RAN) device may receive a measurement report from the end device, which can aid the RAN device in making handover decisions. However, depending on how rapidly radio conditions may be changing, the use of the measurement report may yield undesirable results. For example, during rapidly changing radio conditions, the radio connection between the end device and the RAN device may deteriorate and/or result in a loss of the radio connection. According to another example, rapidly changing radio conditions may cause degradation of an application session (e.g., voice call drop, cannot satisfy a service level agreement (SLA) value, a Quality of Service (QoS) metric or identifier (5QI), etc.) and/or the like.

Uplink (UL) metrics may be used to improve handover trigger mechanisms and handover decisions. However, depending on configured threshold values, handover triggers and/or decisions may be satisfied too often or too soon, which may diminish or shrink the serving cell coverage and yield excessive and/or unnecessary handovers. Conversely, handover triggers and/or decisions may be satisfied less often or not soon enough, which may increase or expand the serving cell coverage and not afford necessary handovers to occur. For example, threshold handover trigger values that may accommodate low mobility users may cause issues for mid or high mobility users and yield QoS issues (e.g., call drops, audio gaps for Voice over New Radio (VoNR), extra delay for consumer Internet of Things (CIoT), etc.), and/or the like.

According to exemplary embodiments, a dynamic handover trigger service is described. According to an exemplary embodiment, an access device (e.g., a RAN device) may include logic of the dynamic handover trigger service, as described herein. According to an exemplary embodiment, the logic of the dynamic handover trigger service may include artificial intelligence or machine learning (AI/ML), as described herein. For example, the AI/ML may include logic that optimizes adjustable handover trigger threshold values, as described herein.

According to an exemplary embodiment, the handover trigger threshold values may include a range of handover trigger thresholds. For example, the range may indicate a minimum value and a maximum value, as described herein. According to an exemplary embodiment, the handover threshold values may be based on and/or correlated to several types of data, as described herein. For example, according to an exemplary embodiment, the handover trigger threshold value may be implemented to include an uplink radio condition value, such as an uplink SINR value. According to an exemplary embodiment, the uplink SINR value may be correlated to at least one of an uplink SINR variance value, a packet delay value, a packet loss value, a doppler shift value, end device mobility information (e.g. end device speed and/or velocity value(s); location, etc.), end device capability information, or type of service information, as described herein.

According to an exemplary embodiment, the RAN device may determine whether to invoke a handover based on a comparison of measured uplink values (e.g., uplink SINR value and one or more other data values (e.g., uplink SINR variance value, packet loss value, packet delay value, etc.)) to optimized handover trigger threshold values via AI/ML logic that may be stored or accessed by the RAN device.

According to an exemplary embodiment, the RAN device may trigger or invoke a handover procedure with the end device of relevance when the compared values satisfy the optimized handover trigger threshold values.

In view of the foregoing, the dynamic handover trigger service may adjust and optimize handover trigger thresholds, which may include various uplink metrics beyond uplink SINR, as well as other data (e.g., end device capability, type of service, end device mobility information, etc.), as described herein, that enable timely handovers for end devices. Additionally, the handover trigger threshold values may be defined by a range or levels of handover threshold values in which each level may correlate to unique values of the various uplink metrics and other data, as described herein. In this way, the dynamic handover trigger service may improve network performance and other aspects of network-side and end device-side wireless services.

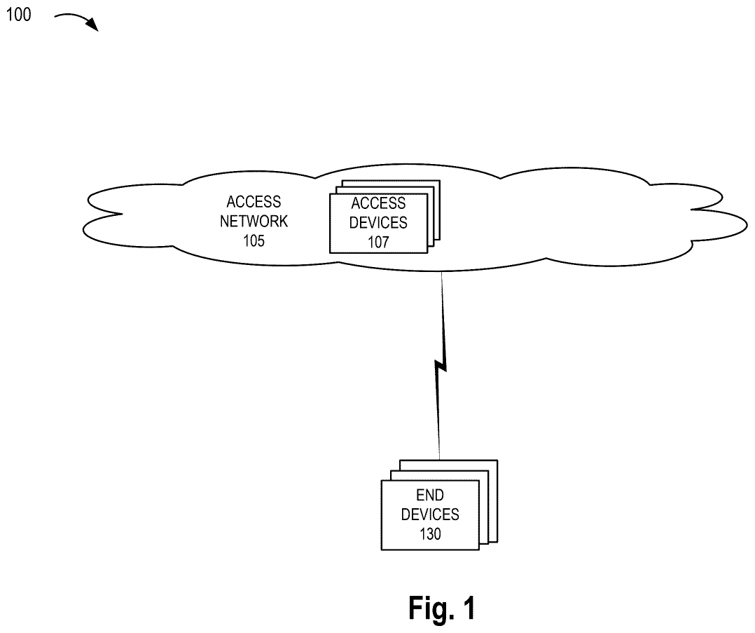

FIG. 1 is a diagram illustrating an exemplary environment 100 in which an exemplary embodiment of the dynamic handover trigger service may be implemented. As illustrated, environment 100 includes an access network 105 and end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, a core network, an application layer network (e.g., the Internet, a data network, etc.) that may provide end device applications and/or services, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the dynamic handover trigger service may use at least one of these planes of communication.

Access network 105 may include one or multiple networks of one or multiple types and technologies. For example, access network 105 may be implemented to include a Fifth Generation (5G) RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

Access network 105 may include different and multiple functional splitting, such as options 1, 2, 3, 4, 5, 6, 7, or 8 that relate to combinations of access network 105 and a core network (not illustrated) including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), a transport device (e.g., a router or similar network device that may support a transport layer protocol (e.g., user datagram protocol (UDP), transmission control protocol (TCP), QUIC, Real-time Transport Protocol (RTP), etc.), and/or some sub-combination such access devices 107.

Access device 107 may include other types of wireless access devices, such as a Wi-Fi device, a hotspot device, and/or a fixed wireless access customer premise equipment (fixed wireless access (FWA) CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5.5G functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector/zone, carrier, and/or other configurable level. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the types of access device 107 (e.g., small cell device versus gNB, etc.), attributes of access device 107 (e.g., antenna configuration, radio frequency band of beam, etc.), and/or other factors (e.g., terrain of the radio covered locale).

According to an exemplary embodiment, at least some of access devices 107 may include logic of the dynamic handover trigger service, as described herein. For example, such access devices 107 may select a dynamic and/or optimized handover trigger threshold level value based on uplink radio condition values, such as uplink SINR, uplink SINR variance, packet delay, packet loss, etc., as described herein, and other types of information, such as end device capability information, and/or service type information. These access devices 107 may also make handover decisions based on downlink radio frequency values (e.g., downlink RSRP, downlink SINR, downlink RSRQ, etc.) associated with an end device measurement report (e.g., UE measurement report, etc.). These access devices 107 may select a target cell for end device 130 to handover based on this information.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a music device, an IoT device, a drone, a smart device, an autonomous vehicle, or another type of wireless device (e.g., another type of user equipment (UE)).

End device 130 may be configured to execute various types of software (e.g., applications, programs, etc.). The number and the types of software may vary among end devices 130. For example, end device 130 may host one or multiple end device applications that may relate to diverse types of application services described in relation to external devices 117. For example, the end device application may pertain to IoT, extreme real-time communications, gaming, voice, video-calling, navigation, ultra-reliable communications, and so forth. The end device application may include a client-side application.

End device 130 may include “edge-aware” and/or “edge-unaware” application service clients. For purposes of description, end device 130 is not considered a network device. End device 130 may be implemented as a virtualized device in whole or in part.

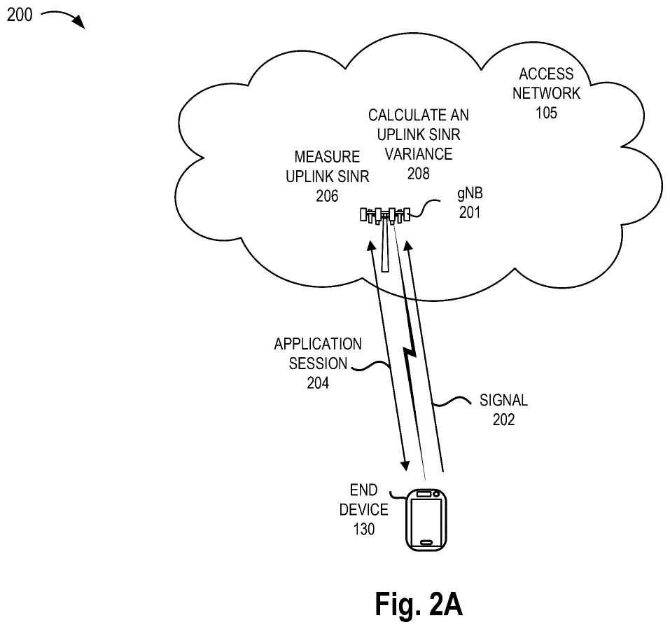

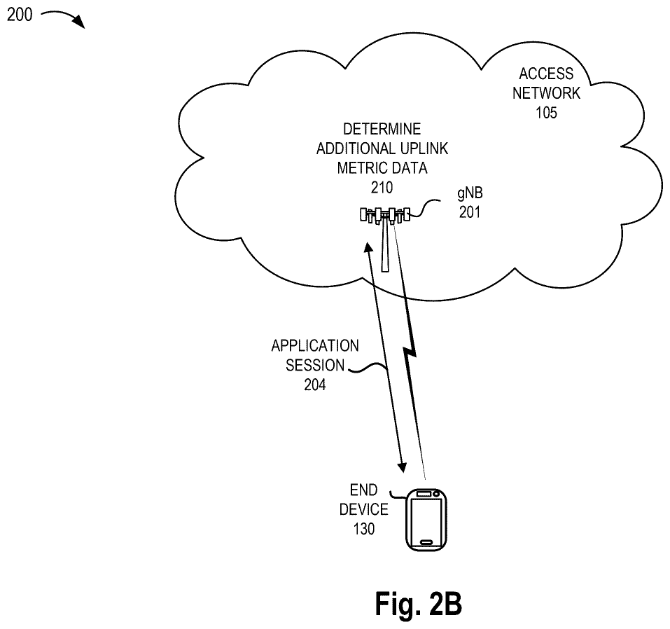

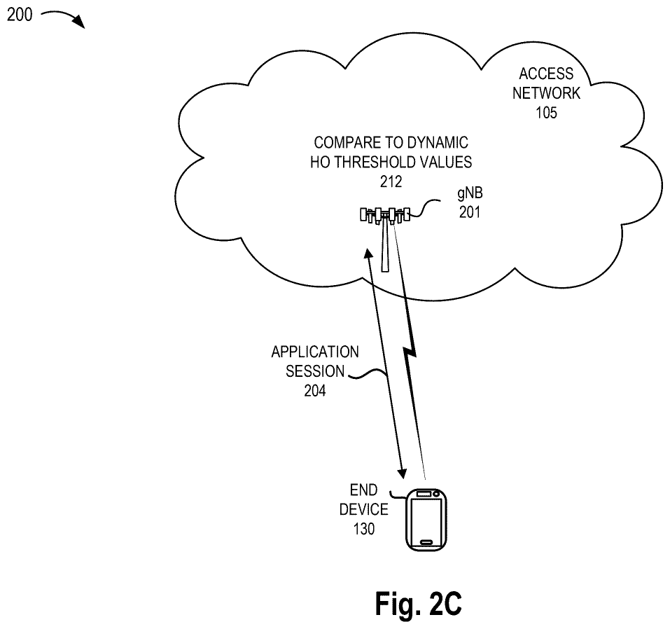

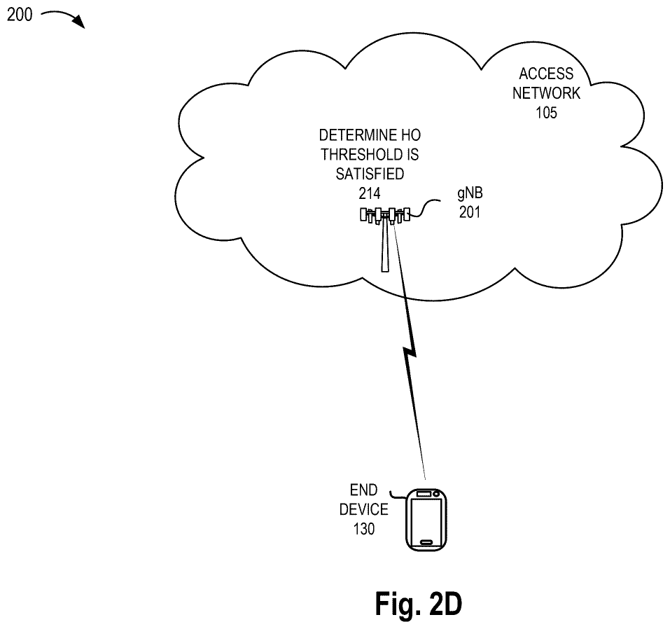

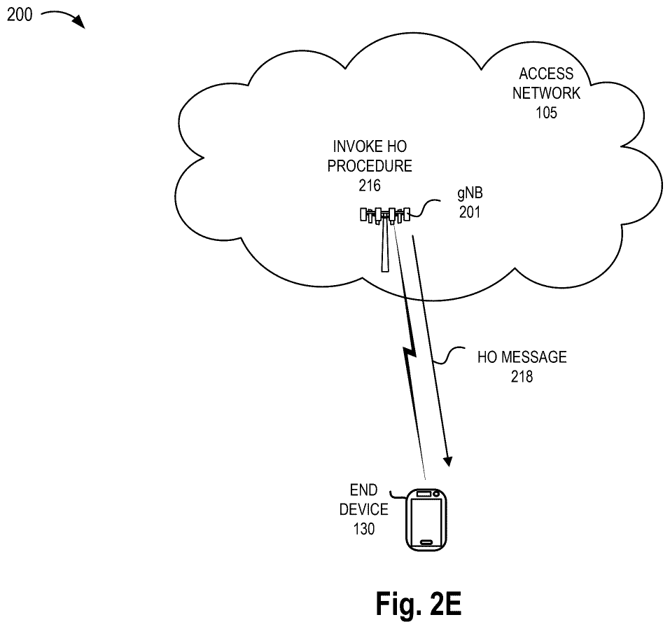

FIGS. 2A-2E are diagrams illustrating an exemplary process of an exemplary embodiment of the dynamic handover trigger service according to an exemplary scenario and an exemplary environment. As illustrated, the exemplary environment may include access network 105, a gNB 201, and end device 130. gNB 201 is an exemplary implementation of access device 107 that includes logic of an exemplary embodiment of the dynamic handover trigger service. According to other exemplary implementations, access device 107 may be implemented by a different type of access device 107, as described herein. For example, access device 107 may be implemented as an integrated RU and DU, an eNB, a DU, a 6G wireless station, and so forth.

For purposes of description, gNB 201 may provide a function and/or a service in accordance with a network standard, such as Third Generation Partnership Project (3GPP), 3GPP2, International Telecommunication Union (ITU), European Telecommunications Standards Institute (ETSI), GSM Association (GSMA), or the like and/or of a proprietary nature. Additionally, gNB 201 may perform a function, an operation, and/or a service that is beyond a function and/or service associated with the network standard in accordance with the dynamic handover trigger service. The messages described and illustrated are exemplary.

According to an exemplary scenario, assume that end device 130 has an active application session 204, which may include the transmission and reception of packets via gNB 201. For example, although not illustrated, end device 130 may have the active application session 204 with a server (e.g., an Internet server, a multi-access edge computing (MEC) server, a data network (DN) server, or another type of application layer network service that may provide an end device application service). By way of further example, the application session may relate to a voice call, a video call, web surfing, extreme real-time communications (e.g., tactile Internet, augmented reality (AR), virtual reality (VR), etc.), a navigation service, or another type of a wireless end device application service.

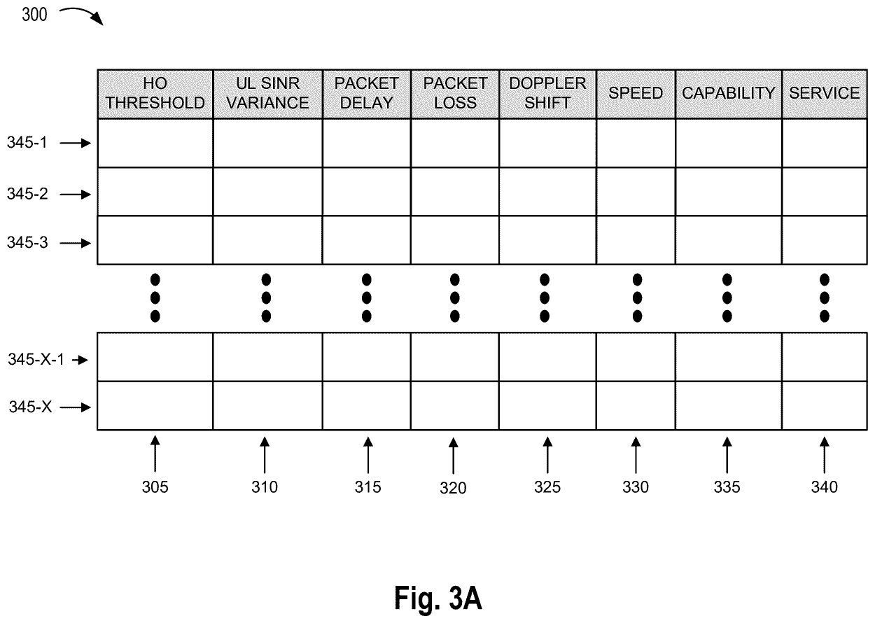

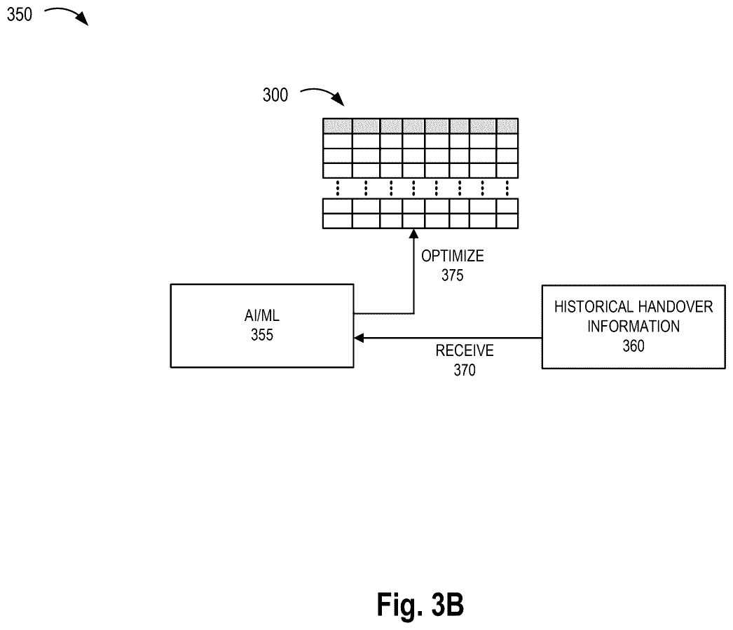

According to an exemplary embodiment, gNB 201 may store dynamic handover threshold information, as described herein. For example, an exemplary implementation of the dynamic handover threshold information is described and illustrated further in relation to FIG. 3A. According to other exemplary embodiments, the dynamic handover threshold information may be stored at another network device to which gNB 201 or another implementation of access device 107 has access.

Referring to FIG. 2A, gNB 201 may measure an uplink SINR 206. For example, end device 130 may transmit a signal 202 to gNB 201. For example, signal 202 may be implemented as a sounding reference signal (SRS). According to this example, gNB 201 may calculate an uplink SINR variance 208 based on measurements of uplink SINR 206. For example, the variance may be a measure of dispersion or how far a set of uplink SINR values may be spread out from their average or mean value, for example. According to one exemplary implementation, gNB 201 may take the square of the standard deviation to calculate the variance.

Referring to FIG. 2B, gNB 201 may determine additional uplink metric data 210. For example, gNB 201 may measure a packet delay and/or a packet loss in relation to packets of application session 204. Additionally, or alternatively, gNB 201 may measure or calculate a doppler shift and/or a speed of end device 130. Additionally, or alternatively, gNB 201 may identify end device capability information of end device 130 and/or the service type associated with application session 204. For example, the end device capability information may include the frequency band(s) supported, the RAT(s) supported, the number of transceivers, CA capability, slot aggregation capability, and/or another type of RF, physical layer, and/or feature group information. According to some exemplary embodiments, although not illustrated, end device 130 may transmit end device capability information (e.g., user equipment (UE) capability information) during a Radio Resource Control (RRC) connected state. The service type information may include data indicating a category of an end device application/session (e.g., IoT, extreme real-time, ultra-reliable, Internet, etc.), 5QI associated with end device application/session, a particular end device application/session (e.g., voice, etc.), or the like. For example, gNB 201 may identify or determine service type information associated with application session 204 based on RAN slice information, the RRC connection, packet inspection, a packet data unit (PDU) session establishment request, and/or the like.

Referring to FIG. 2C, gNB 201 may compare the measured and/or determined values to the dynamic handover threshold values 212. Exemplary dynamic handover threshold information is described in relation to FIG. 3A.

FIG. 3A is a diagram illustrating exemplary dynamic handover threshold information. For example, referring to a table 300 in FIG. 3A, exemplary dynamic handover threshold information is illustrated. Table 300 may include a handover threshold field 305, an UL SINR variance field 310, a packet delay field 315, a packet loss field 320, a doppler shift field 325, a speed field 330, a capability field 335, and a service field 340. According to other exemplary embodiments, table 300 may include additional, different, and/or fewer data fields than those illustrated and described. For example, table 300 may include cell information (e.g., frequency band), sector and/or geo-bin (e.g., location information of end device 130), UL bitrate, UL throughput, and/or other context information to which other correlated data fields may apply. According to various exemplary embodiments, a data field may store a single value or a range of values (e.g., minimum and maximum values) and an associated unit of measure (e.g., decibel, unit of time, percentage, miles per hour (mph), etc.).

As further illustrated, table 300 includes entries 345-1 through 345-X (also referred as entries 345, or individually or generally as entry 345) that each includes a grouping of fields 305 through 340 that are correlated. According to an exemplary embodiment, each entry 345 may indicate a unique handover threshold level. For example, for each entry 345, the correlated values included in fields 305 through 330 may be unique relative to other entries 345. According to other examples, additional or fewer values may or may not be unique.

The dynamic handover threshold information is illustrated in tabular form merely for the sake of description. In this regard, dynamic handover threshold information may be implemented in a data structure different from a table (e.g., a list, a flat file, etc.), a database, or another type of structure. According to other embodiments, the values or instances of information stored in a data field, as described herein, may be different. The number of entries 345 are exemplary for the sake of description purposes.

Handover threshold field 305 may store an UL radio condition value. For example, the UL radio condition value may be implemented as an UL SINR value. UL SINR variance field 310 may store an UL SINR variance value.

Packet delay field 315 may store a packet delay value. For example, the packet delay value may indicate a packet delay budget (PDB) value, such as a maximum allowable delay for packets.

Packet loss field 320 may store a packet loss value. For example, the packet loss value may indicate a percentage of packets loss relative to the packets sent.

Doppler shift field 325 may store a Doppler shift value and/or a Doppler variation rate value. Speed field 330 may store a speed value associated with end device 130. For example, the speed value may have a unit of measure of meters/second, mph, or the like.

Capability field 335 may store one or multiple types of end device capability information pertaining to RF, physical layer, and/or a feature group, as described herein. Service field 340 may store data indicating a category of an end device application/session, a 5QI, a QoS associated with the end device application/session (e.g., latency, throughput, bitrate, packet error rate, etc.), and/or the like, as described herein.

According to other exemplary embodiments, table 300 may store additional and/or different instances of dynamic handover threshold information in support of the dynamic handover trigger service, as described herein.

Referring to FIG. 3B, an exemplary process 350 of an exemplary embodiment of the dynamic handover trigger service is illustrated. For example, process 350 may include an AI/ML 355, historical handover information 360, and table 300. Table 300 has been previously described. According to an exemplary embodiment, AI/ML 355 and/or historical handover information 360 may be configured in access device 107 that performs a handover. According to another exemplary embodiment, AI/ML 355 and/or historical handover information 360 may be configured in a network device other than access device 107 that performs the handover.

AI/ML 355 may include an AI/ML model. For example, the model may be implemented as a neural network model (NNM) and/or another type of model (e.g., a Generalized Linear Model (GLM), etc.). According to an exemplary embodiment, the dynamic network dynamic handover trigger service may use an optimization algorithm, such as a reinforcement learning algorithm or another type of learning algorithm (e.g., supervised learning, etc.). According to some exemplary embodiments,

Historical handover information 360 may include a database or a data structure that may store historical handover threshold information. For example, historical handover information 360 may store historical handover event information pertaining to handovers. The historical handover event information may include historical dynamic handover threshold information pertaining to a handover (e.g., handover threshold level and correlated optimized threshold values, measured values upon which the handover threshold value was selected, etc.) and an outcome of the handover (e.g., success or failure). The historical handover event information may include day and timestamp information, cell and/or sector information associated with the source and/or target, and the like.

As illustrated, AI/ML 355 may receive 370 historical handover information 360. Based on historical handover information 360, AI/ML 355 may determine whether any values of the dynamic handover threshold information (e.g., value included in table 300) should be adjusted or optimized. When AI/ML 355 determines that a value is to be adjusted, AI/ML 355 may dynamically adjust and optimize 375 the value of the dynamic handover threshold information stored in table 300, for example, based on the optimization algorithm of AI/ML 355.

Referring back to FIG. 2C, gNB 201 may compare two or more data instances of a handover threshold level (e.g., entry 345) to corresponding measured or determined handover threshold values. For example, gNB 201 may compare data values of fields 305-315 to their corresponding measured values or another combination of data value in field 305 and one or more other data values in fields 310-340 to the measured and/or determined values. Based on a result of the comparison, gNB 201 may determine whether there is a match or not.

Referring to FIG. 2D, according to this exemplary scenario, gNB 201 may determine that there is a match with two or more data values of entry 345. As an example, the measured UL SINR value and at least one of UL SINR variance value, packet delay value, packet loss value, doppler shift value, speed value, capability information, or service information may match one of entries 345. Based on the result of the match, gNB 201 may determine that the handover threshold is satisfied 214.

Referring to FIG. 2E, in response to the handover threshold being satisfied, gNB 201 may trigger a handover procedure 216. For example, although not illustrated, gNB 201 may select a candidate cell (e.g., from one or multiple candidate cells) as the target cell for the handover based on an end device measurement report from end device 130. As a part of the handover procedure 216, gNB 201 may transmit a handover message 218, which may include the selected target cell, to end device 130.

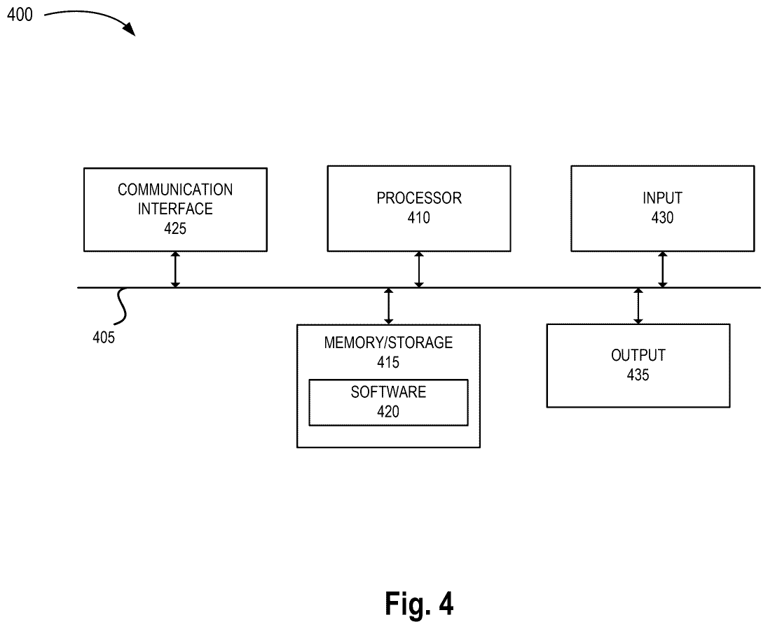

FIG. 4 is a diagram illustrating exemplary components of a device 400 that may be included in one or more of the devices described herein. For example, device 400 may correspond to access device 107, end device 130, AI/ML 355, and/or other types of devices, as described herein. As illustrated in FIG. 4, device 400 includes a bus 405, a processor 410, a memory/storage 415 that stores software 420, a communication interface 425, an input 430, and an output 435. According to other embodiments, device 400 may include fewer components, additional components, different components, and/or a different arrangement of components than those illustrated in FIG. 4 and described herein.

Bus 405 includes a path that permits communication among the components of device 400. For example, bus 405 may include a system bus, an address bus, a data bus, and/or a control bus. Bus 405 may also include bus drivers, bus arbiters, bus interfaces, clocks, and so forth.

Processor 410 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 410 may be implemented as hardware (e.g., a microprocessor, etc.), a combination of hardware and software (e.g., a SoC, an ASIC, etc.), may include one or multiple memories (e.g., cache, etc.), etc.

Processor 410 may control the overall operation, or a portion of operation(s) performed by device 400. Processor 410 may perform one or multiple operations based on an operating system and/or various applications or computer programs (e.g., software 420). Processor 410 may access instructions from memory/storage 415, from other components of device 400, and/or from a source external to device 400 (e.g., a network, another device, etc.). Processor 410 may perform an operation and/or a process based on various techniques including, for example, multithreading, parallel processing, pipelining, interleaving, learning, model-based, etc.

Memory/storage 415 includes one or multiple memories and/or one or multiple other types of storage mediums. For example, memory/storage 415 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 415 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 415 may be external to and/or removable from device 400, such as, for example, a Universal Serial Bus (USB) memory stick, a dongle, a hard disk, mass storage, off-line storage, or some other type of storing medium. Memory/storage 415 may store data, software, and/or instructions related to the operation of device 400.

Software 420 includes an application or a program that provides a function and/or a process. As an example, with reference access device 107 and/or AI/ML 355, software 420 may include an application that, when executed by processor 410, provides a function and/or a process of the dynamic handover trigger service, as described herein. Software 420 may also include firmware, middleware, microcode, hardware description language (HDL), and/or another form of instruction. Software 420 may also be virtualized. Software 420 may further include an operating system (e.g., Windows, Linux, Android, proprietary, etc.).

Communication interface 425 permits device 400 to communicate with other devices, networks, systems, and/or the like. Communication interface 425 includes one or multiple wireless interfaces, optical interfaces, and/or wired interfaces. For example, communication interface 425 may include one or multiple transmitters and receivers, or transceivers, an antenna, and the like. Communication interface 425 may operate according to a protocol stack and a communication standard.

Input 430 permits an input into device 400. For example, input 430 may include a keyboard, a mouse, a display, a touchscreen, a touchless screen, a button, a switch, an input port, speech recognition logic, and/or some other type of visual, auditory, tactile, affective, olfactory, etc., input component. Output 435 permits an output from device 400. For example, output 435 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 400 may be implemented in the same manner. For example, device 400 may be instantiated, created, deleted, or some other operational state during its life cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 400 may be configured to perform a process and/or a function, as described herein, in response to processor 410 executing software 420 stored by memory/storage 415. By way of example, instructions may be read into memory/storage 415 from another memory/storage 415 (not shown) or read from another device (not shown) via communication interface 425. The instructions stored by memory/storage 415 may configure processor 410 to perform a function, an operation, or a process described herein. Alternatively, for example, according to other implementations, device 400 may be configured to perform a function, an operation, or a process described herein based on the execution of hardware (processor 410, etc.).

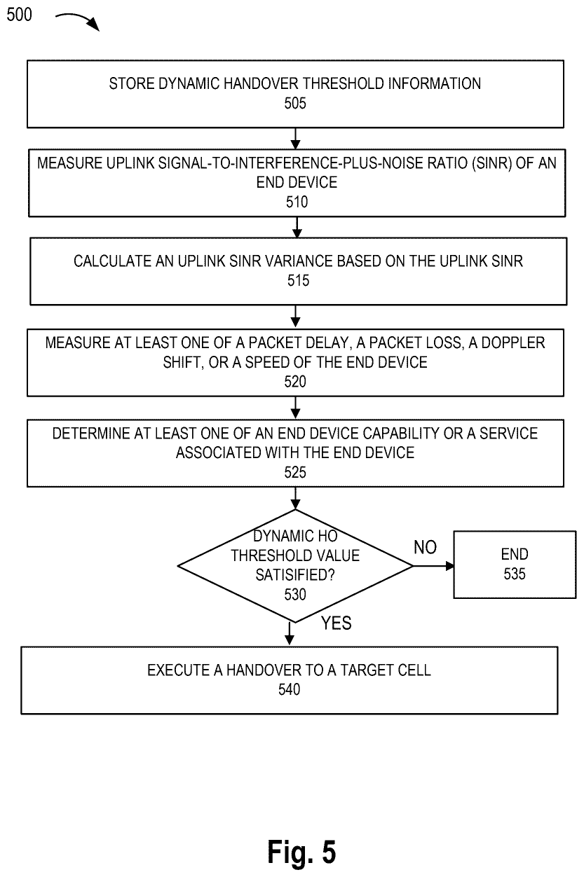

FIG. 5 is a flow diagram illustrating an exemplary process 500 of an exemplary embodiment of the dynamic handover trigger service. According to an exemplary embodiment, access device 107, as described herein, may perform steps of process 500. According to an exemplary implementation, a processor may execute software to perform a step (in whole or in part) of process 500, as described herein. Alternatively, a step (in whole or in part) may be performed by execution of only hardware.

In block 505, access device 107 may store dynamic handover threshold information. For example, access device 107 may store handover threshold information, as described in relation to FIG. 3 and elsewhere.

In block 510, access device 107 may measure uplink SINR of an end device 130.

In block 515, access device 107 may calculate an UL SINR variance based on the UL SINR.

In block 520, access device 107 may measure at least one of packet delay, packet loss, a doppler shift, or a speed of end device 130.

In block 525, access device 107 may determine at least one of an end device capability or a service associated with end device 130.

In block 530, access device 107 may determine whether a dynamic handover threshold is satisfied or not. For example, access device 107 may compare the UL SINR and at least one of the UL SINR value, the packet delay, the packet loss, the doppler shift, the speed, the end device capability, or the service to the dynamic handover threshold information.

When access device 107 determines that there is not a match (block 530-NO), process 500 may end (block 535).

When access device 107 determines that there is a match (block 530-YES), access device 107 may execute a handover to a target cell (block 540). For example, access device 107 may select a target cell based on an end device measurement report associated with candidate cells.

FIG. 5 illustrates an exemplary process 500 of the dynamic handover trigger service, however, according to other exemplary embodiments, the dynamic handover trigger service may perform additional operations, fewer operations, and/or different operations than those illustrated and described in relation to FIG. 5. For example, optionally, access device 107 may not perform block 515, block 520, or block 525. According to another example, optionally, access device 107 may not perform two of blocks 515, 520, and 525. For example, access 107 may not perform blocks 515 and 520 or blocks 520 and 525.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while a series of blocks has been described regarding the process illustrated in FIG. 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element. ” The logic, the component, or the element, may include, for example, hardware (e.g., processor 410, etc.), or a combination of hardware and software (e.g., software 420).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 410) of a device. A non-transitory storage medium includes one or more of the storage mediums described in relation to memory/storage 415. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
storing, by a network device, handover threshold information that includes multiple handover trigger levels, wherein each handover trigger level includes unique uplink radio condition threshold values correlated to one or more of a unique end device speed threshold value, a doppler shift threshold value, an application service value, or end device capability information;
measuring, by the network device, a first uplink radio condition value pertaining to an end device;
calculating, by the network device, an uplink radio condition variance value based on the first uplink radio condition value;
measuring, by the network device, one or more second uplink radio condition values or an end device speed value;
comparing, by the network device, the first uplink radio condition value, the uplink radio condition variance value and, the one or more second uplink radio condition values or the end device speed value to the handover threshold information; and
determining, by the network device based on a result of the comparing, to execute a handover for the end device.

2. The method of claim 1, wherein the first uplink radio condition value is an uplink signal-to-noise-and-interference (SINR) value, and the uplink radio condition variance value is an uplink SINR variance value.

3. The method of claim 1, wherein the one or more second uplink radio condition values include one or more of packet loss or packet delay.

4. The method of claim 1, further comprising:
determining, by the network device, an application service associated with an application session and the end device; and
comparing, by the network device, the application service value of the handover threshold information to the application service.

5. The method of claim 1, further comprising:
determining, by the network device, capability information of the end device; and
comparing, by the network device, the end device capability information of the handover threshold information to the capability information of the end device.

6. The method of claim 1, further comprising:
optimizing, by the network device, the handover threshold information based on historical handover information and machine learning logic.

7. The method of claim 1, further comprising:
selecting, by the network device, a target cell of the handover based on a measurement report from the end device.

8. The method of claim 1, wherein the network device is a radio access network (RAN) device of a radio access network.

9. A network device comprising:
a processor, wherein the processor is configured to:
store handover threshold information that includes multiple handover trigger levels, wherein each handover trigger level includes unique uplink radio condition threshold values correlated to one or more of a unique end device speed threshold value, a doppler shift threshold value, an application service value, or end device capability information;
measure a first uplink radio condition value pertaining to an end device;
calculate an uplink radio condition variance value based on the first uplink radio condition value;
measure one or more second uplink radio condition values or an end device speed value;
compare the first uplink radio condition value, the uplink radio condition variance value and, the one or more second uplink radio condition values or the end device speed value to the handover threshold information; and
determine, based on a result of the comparison, to execute a handover for the end device.

10. The network device of claim 9, wherein the first uplink radio condition value is an uplink signal-to-noise-and-interference (SINR) value, and the uplink radio condition variance value is an uplink SINR variance value.

11. The network device of claim 9, wherein the one or more second uplink radio condition values include one or more of packet loss or packet delay.

12. The network device of claim 9, wherein the processor is further configured to:
determine an application service associated with an application session and the end device; and
compare the application service value of the handover threshold information to the application service.

13. The network device of claim 9, wherein the processor is further configured to:
determine capability information of the end device; and
compare the end device capability information of the handover threshold information to the capability information of the end device.

14. The network device of claim 9, wherein the processor is further configured to:
optimize the handover threshold information based on historical handover information and machine learning logic.

15. The network device of claim 9, wherein the processor is further configured to:
select a target cell of the handover based on a measurement report from the end device.

16. The network device of claim 9, wherein the network device is a radio access network (RAN) device of a radio access network.

17. A non-transitory computer-readable storage medium storing instructions executable by a processor of a network device, wherein the instructions are configured to:
store handover threshold information that includes multiple handover trigger levels, wherein each handover trigger level includes unique uplink radio condition threshold values correlated to one or more of a unique end device speed threshold value, a doppler shift threshold value, an application service value, or end device capability information;
measure a first uplink radio condition value pertaining to an end device;
calculate an uplink radio condition variance value based on the first uplink radio condition value;
measure one or more second uplink radio condition values or an end device speed value;
compare the first uplink radio condition value, the uplink radio condition variance value and, the one or more second uplink radio condition values or the end device speed value to the handover threshold information; and
determine, based on a result of the comparison, to execute a handover for the end device.

18. The non-transitory computer-readable storage medium of claim 17, wherein the first uplink radio condition value is an uplink signal-to-noise-and-interference (SINR) value, and the uplink radio condition variance value is an uplink SINR variance value.

19. The non-transitory computer-readable storage medium of claim 17, wherein the instructions are further configured to:
optimize the handover threshold information based on historical handover information and machine learning logic.

20. The non-transitory computer-readable storage medium of claim 17, wherein the instructions are further configured to:
select a target cell of the handover based on a measurement report from the end device.
